(19) United States
(12) Patent Application Publication
(10) Pub. No.: US 2009/0117919 A1
(43) Pub. Date: May 7, 2009

(54) System for controlling a personal electronic device

(76) Inventor: Matthew J. Hershenson, Los Altos, CA (US)

Correspondence Address: SADLER, BREEN, MORASCH & COLBY, P.S., 422 W. RIVERSIDE AVE., SUITE 424, SPOKANE, WA, 99201, US

(21) Appl. No.: 10/263,084

(22) Filed: Oct. 1, 2002

(51) Int. Cl. H04W 24/00

(52) U.S. Cl. 455/456.4

(57) ABSTRACT

A system and method of controlling a personal electronic device is described. The system includes a personal electronic device coupled to a sensor that can detect a safety signal. The system can also include a safety signal source.

### FIELD OF THE INVENTION

The present invention relates to systems and methods of controlling a personal electronic device and more specifically to a system and method for disabling a personal electronic device within a restricted area.

### BACKGROUND OF THE INVENTION

Various types of personal electronic devices are available today including cell phones, notebook computers, personal digital assistants (“PDAs”), electronic books, portable video games, citizen band (“CB”) receiver transmitters, and family recreational service (“FRS”) receiver transmitters, to name a few. The use of the personal electronic devices is restricted in certain areas for various safety, security and other reasons. For example cellular telephones must be disabled on an aircraft because the radio frequency (“RF”) transmissions may cause interference with the aircraft's electronic systems. Cell phones and other devices are restricted in hospitals due to concerns of RF transmissions interfering with diagnostic and life support equipment. Other restricted areas include blasting zones where remote control blasting systems are used, laboratories with sensitive testing equipment and secretive research and development facilities.

Certain portable devices have become so small in size, that the user may not remember to disable the device when entering into a restricted area. For example, when traveling, many users store powered cell phones or PDAs within a briefcase. These users may not always remember to disable the powered device upon entering an airplane, hospital or other restricted area.

Accordingly, what is needed is an improved system and method for controlling personal electronic devices under certain conditions or within certain areas.

### SUMMARY OF THE INVENTION

A system and method of controlling a personal electronic device is described. The system includes a personal electronic device coupled to a sensor that can detect a safety signal. The system can also include a safety signal source.

In an alternative embodiment, the method can include detecting a safety signal in a sensor coupled to a personal electronic device and responsively disabling the personal electronic device.

### BRIEF DESCRIPTION OF THE DRAWINGS

The present invention is illustrated by way of example and not limitation in the figures of the accompanying drawings in which like references indicate similar elements.

FIG. 1 illustrates one embodiment of a personal electronic device controlling system installed on an aircraft.

FIG. 2 illustrates one embodiment of a personal electronic device controlling system installed around a blasting zone.

FIG. 3 shows one embodiment of the system for controlling a personal electronic device.

FIG. 3A shows a block diagram showing the principle components of cellular telephone 305 of one embodiment.

FIG. 3B shows a personal digital assistant coupled to a sensor.

FIG. 4 shows one embodiment of the process of controlling a personal electronic device.

FIG. 4A illustrates one of the embodiments of a process for resetting a personal electronic device.

### DETAILED DESCRIPTION

As will be described in more detail below, what is described herein as a system and method for disabling personal electronic devices in a restricted area such as a aircraft, or a hospital, a blasting zone, or other restricted areas.

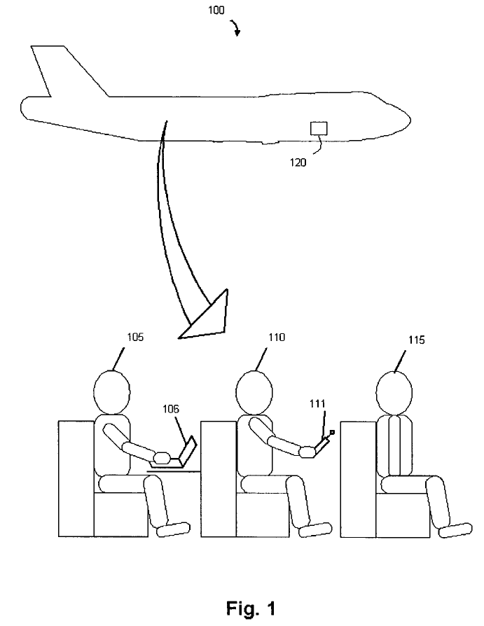

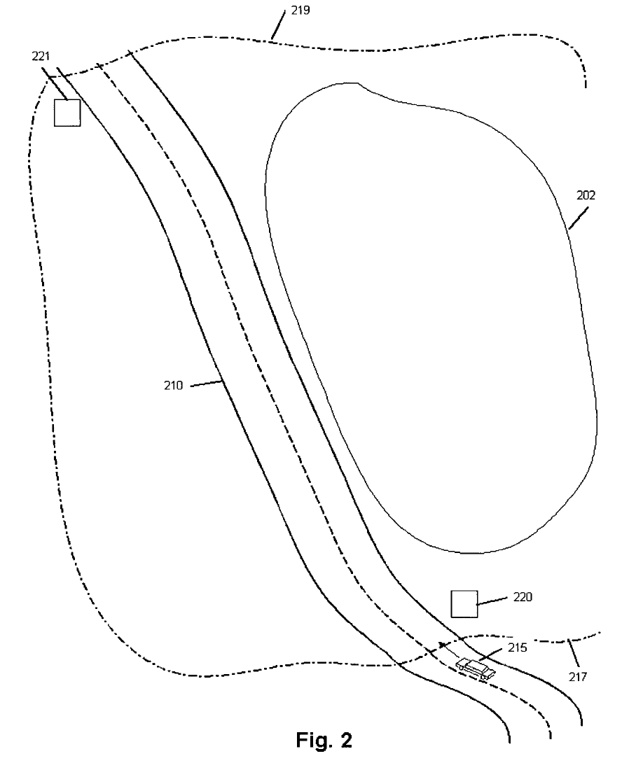

FIGS. 1 and 2 illustrates two different circumstances under which the automatic control functions described herein may be employed. FIG. 1 illustrates one embodiment of a personal electronic device safety system installed on an aircraft 100. Several passengers 105, 110, 115 are shown seated in their respective seats on board the aircraft 100. A first passenger 105 is show using a notebook computer 106. A second passenger 110 is shown using a PDA/cellular telephone combination 111. A safety signal source 120 is also shown on board the aircraft 100.

FIG. 2 illustrates one embodiment of a personal electronic device safety system installed around the perimeter of a blasting zone 202. Often blasting zones are located near a roadway 210. An automobile 215 is shown passing by the blasting zone 202. Blasting zones are commonly marked by some sort of perimeter marking such as a fence or posted signs warning of the blasting activities. In FIG. 2, the perimeter of the blasting zone 202 is marked by perimeter markings 217, 219. Safety signal sources 220, 221 are also shown immediately adjacent to the perimeter markings 217, 219.

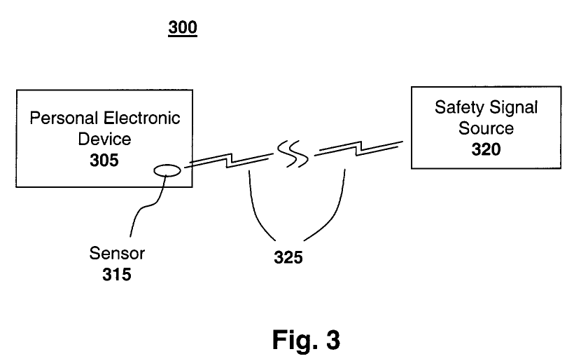

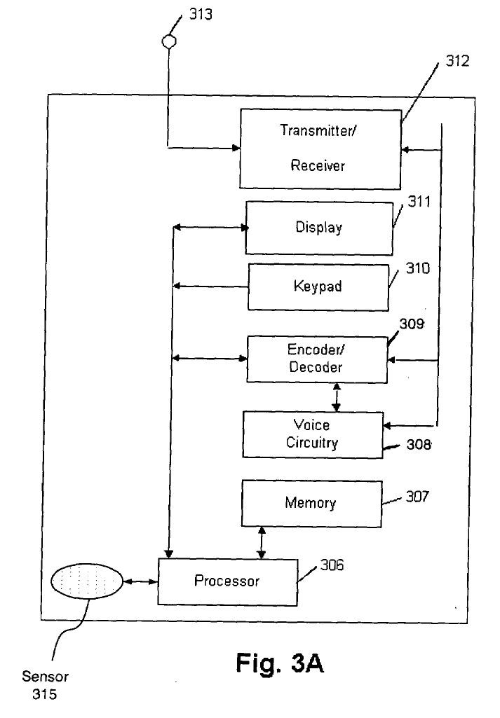

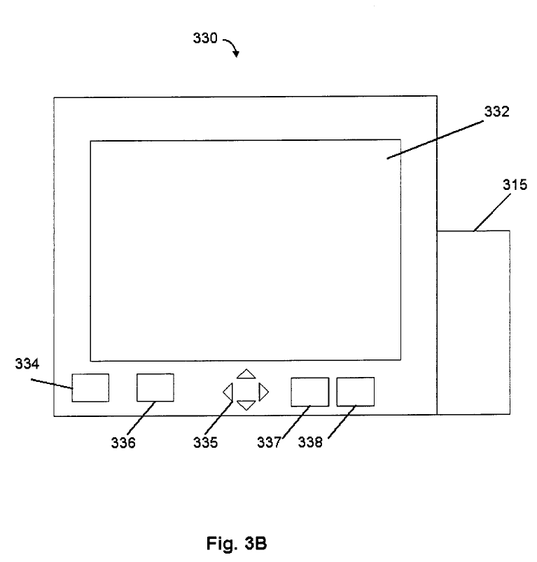

FIG. 3 shows one embodiment of the safety system for controlling a personal electronic device 305. The system includes a personal electronic device 305 comprising a sensor 315, a safety signal source 320 and a safety signal 325 generated by the safety signal source 320.

Returning to FIG. 1, various different types of safety signals may be employed within the aircraft 100. In one embodiment, an RF signal is employed. For example, a unique identification code or other signal embodied in an RF carrier wave may be transmitted from the safety signal source 120. Upon being detected by the electronic device via the sensor 315, the electronic device powers down or, alternatively, enters into some type of “sleep” state in which signal transmissions from the device are disabled. In one embodiment, a separate sensor 315 may not be required to detect the safety signal. For example, the safety signal source 120 may transmit the safety identification code within the same frequency band and/or using the same modulation techniques as those employed for audio and data communication by the cell phone or other wireless device. The specific safety identification code/signal may be previously agreed to by wireless device manufacturers.

In an area which is not encapsulated or otherwise well defined, such as the blasting zone 202 of FIG. 2, the safety signal may be embedded within a highly directionalized (i.e., beam formed) radio transmission focused at a particular area. For example, the safety signal sources 220, 221 may direct a safety signal at all automobiles 215 passing into the restricted area. Through well known methods of beam forming the safety signal can be limited to within the proximity of the roadway 210 running through blasting zone 202.

In one embodiment, the sensor is a GPS receiver. The GPS receiver (or the data processing device into which the receiver is embedded) includes a database of locations identified as “restricted.” In response to the GPS receiver detecting that the data processing device has entered a restricted area (e.g., as the personal electronic device passes the perimeter markings 217, 219), it will automatically place the device in a safe mode (e.g., a powered off mode or a “sleep” mode).

The sensor 315 may be any one a number of types of sensors that can receive or detect a safety signal 325. For example, if the safety signal 325 includes a radio transmission then the sensor 315 is an RF receiver. In one embodiment, the safety sensor 315 is a pressure sensor. Thus, in response to a particular pressure change, the data processing device 305 may enter a safe mode. A pressure safety sensor 315 may be particularly useful when employed within an aircraft. The pressure sensor may be used to detect the pressure change caused by an aircraft ascending and/or when the aircraft is initially pressurized before taking off. For example, pilots commonly increase the air pressure within the aircraft prior to take off to confirm that the aircraft cabin can be properly pressurized. In one embodiment the detected pressure change is simply a change from a pressure base line. Alternatively, or in addition, the pressure change can be a measured rate of change or pressure. In yet another embodiment, the data processing device 305 is configured to detect a particular modulation of the air pressure via the pressure sensor 315. Returning to the example of the aircraft preparing for take-off, the aircraft may be pressurized to a predetermined level (i.e. 105% of ambient pressure) for a predetermined amount of time (i.e., 30 seconds). When the data processing device 305 detects the predetermined level of pressure change for a predetermined period of time, it enters into a safe mode.

In one embodiment, the safety sensor detects acceleration, velocity or other kinematic phenomena. Accelerometers can detect motion in excess of a specified velocity or acceleration rate. This implementation may be beneficial for detecting use of the data processing device 305 in an aircraft. For example, if the sensor 315 detects a velocity of 300 mph, it can be safely assumed that the data processing device 305 is on an aircraft (i.e., and therefore place the device in a safe operating mode). Similarly, if the accelerometer detects an acceleration rate greater than a specified rate, then the data processing device 315 will determine the aircraft is on a take-off run and place the device in a safe mode.

Similar to an accelerometer, a GPS receiver can by used to calculate velocity and acceleration rates. For example, based on the global positions provided via the GPS receiver over a specified period of time, the data processing device 315 can calculate its velocity by dividing the distance traveled by the specified period of time. Similarly, the data processing device 315 may calculate acceleration based on the measured increase in velocity over a period of time.

Other safety signals and sensors include ultrasonic signals and sensors capable of detection the ultrasonic signals. A safety signal can also be a light such as a laser or an ultra violet light signal and the sensor can be a device capable of receiving the light or UV signals. In one embodiment, the safety signal can be a signal on a UV light carrier that is beamed to the personal electronic device and received via a UV receptor on the personal electronic device. For example, most hand-held computing devices (e.g., Palm Computing devices) include a UV receptor/transmitter for receiving and transmitting data. The restricted area can include one or more transmitting locations that can transmit the UV safety signal to the hand-held computing device. Once the UV safety signal is received, the personal electronic device processes it similarly to an RF safety signal described above. Various embodiments can also include combinations of the safety signal types and sensor types described herein.

In one embodiment, the safety signal source can also transmit a reset signal to automatically reset or reactivate the personal electronic device. The reset signal is a separate signal similar to the safety signal. In one embodiment, such as on board an aircraft, there may be multiple safety signals such as a first safety signal during take off and landing where all personal electronic devices are placed in a safe mode, and a second safety signal during the certain periods of flight when only certain personal electronic devices (i.e. lap top computers, PDAs, video games, etc) are re-enabled but while other personal electronic devices such as cellular telephones are still placed in a safe mode.

In one embodiment, the safety signal is constant or alternatively periodic (e.g., every ten seconds or thirty seconds or similar intervals). Alternatively, the safety signal can also include an automatic timing element such that the safe operating mode “expires” automatically in a predetermined amount of time and the operating mode is automatically reset to normal operation, unless the safety signal is still present.

In one embodiment, the safe operating mode of the personal electronic devices is to completely disable the personal electronic device such as by interrupting power or otherwise turning the personal electronic device completely off. Alternatively, the safe operating mode can include only limiting the operation of the personal electronic device to certain functions that are determined to be safe modes of operation. For example, many personal electronic devices have been combined such as a cellular phone, and a PDA. As described above, a cellular telephone transmitter is desired to not operate on board an aircraft but the user may wish to still have access to the PDA functions of the device. Therefore the “safe” mode of operation may be to disable the cellular telephone transmitter but allow the other PDA functions to continue to function so that the user can take notes, access contacts information, or research information that is stored on the PDA.

FIG. 3A shows a block diagram showing the principle components of cellular telephone/PDA 305 of one embodiment. The cellular telephone 305 includes a processor 306, which may be or may include any of a general or special purpose programmable microprocessor, Digital Signal Processor (“DSP”), Application Specific Integrated Circuit (“ASIC”), Programmable Logic Array (“PLA”), Field Programmable Gate Array (“FPGA”), . . . etc., or a combination thereof.

The cellular telephone 305 includes memory 307 that stores data and/or software for controlling and/or performing many of the processing tasks performed by cellular telephone 305 such as detecting the safety and reset signals provided by the sensor 315. The memory 307 may represent one or more physical memory devices or facilities, which may include any type of Random Access Memory (“RAM”), Read-Only Memory (“ROM”) (which may be programmable), Flash memory, non-volatile mass storage device, or a combination of such memory devices. The cellular telephone 305 also includes a keypad 310 and display 311.

The cellular telephone 305 also includes voice circuitry 308 for inputting and outputting audio during a telephonic communication between the user of cellular telephone 305 and a remote party. Voice circuitry 308 may include, for example, sound transducers, analog-to-digital (“A/D”) and digital-to-analog (D/A) converters, filters, etc., such as are well known in the art. An encoder/decoder 309 is coupled between the processor 306 and the voice circuitry 308 for encoding and decoding audio signals. The cellular telephone 305 also includes a receiver transmitter circuitry 312 that is coupled to the antenna and the voice circuitry 309 and/or the encoder/decoder 307.

The receiver/transmitter circuitry 312 may also receive a safety signal which the processor 306 may use to place the cellular telephone 305 in a safe operating mode. Similarly, the cellular telephone 305 may receive a reset signal which the processor 306 may use to reset the cellular telephone 305 from safe operating mode.

FIG. 3B shows a personal digital assistant 330 coupled to a sensor 315. In addition, the personal digital assistant has a display screen 332, and various keys and controls 334, 335, 336, 337, and 338 to enable the user to use the PDA.

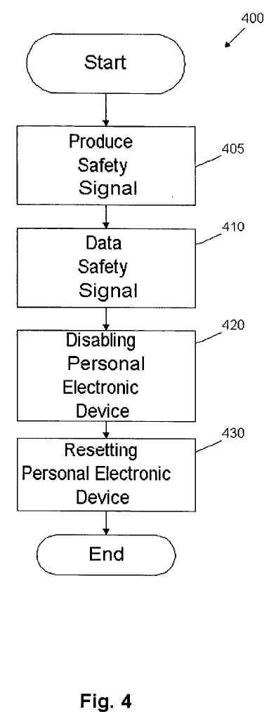

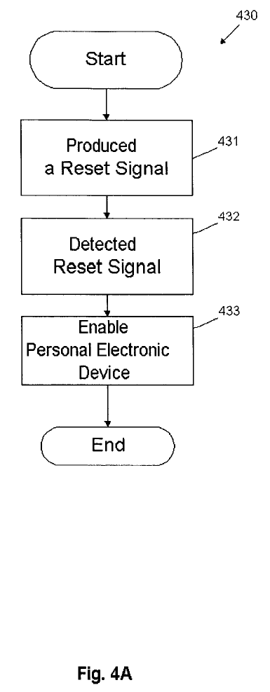

FIG. 4 shows one embodiment of the process of controlling a personal electronic device. In block 405 a safety signal is produced (e.g., by transmitting a signal, achieving a predetermined velocity, acceleration rate, location, . . . etc). In Block 410, the sensor attached to a personal electronic device detects the safety signal. In Block 420, the personal electronic device is disabled as a result of receiving the safety signal. In Block 430, the personal electronic device is reset.

FIG. 4A illustrates one embodiment of a process for resetting the personal electronic device from the safe operating mode, such as in Block 430 of FIG. 4. A reset signal is produced in Block 431 the reset signal is detected by the sensor attached to the personal electronic device in Block 432. The personal electronic device is placed in enabled into normal operating mode in Block 433. The scope of enabling the personal electronic device can include any of the embodiments described above such as enabling the portion of the personal electronic device that was disabled in the safe operating mode.

As described above, the reset signal may be transmitted or created through a timing function within the personal electronic device so that the reset signal may not be produced external to the personal electronic device. Similar to the safety signal, the reset signal can also be a detected condition such as a detected location or velocity. Using the example of the acceleration rate or the velocity detection, once the aircraft has stopped and is no longer moving over 200 mph (or another predetermined number), then the aircraft must be on the ground because most aircraft do not fly below 200 mph. In another embodiment, the reset signal can be a different setting than the safety signal. For example, the safety signal may be a velocity greater than 200 mph and the reset signal may be detecting a velocity of 70 mph or less.

It will be further appreciated that the instructions represented by the blocks in FIGS. 4-4A are not required to be performed in the order illustrated, and that all the processing represented by the blocks may not be necessary to practice the invention.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1-38. (canceled)

39. A method comprising:
defining a danger area in which RF transmissions may be unsafe;
positioning one or more safety signal sources at or around the danger area;
transmitting a first radio frequency (RF) safety signal from the one or more safety signal sources, the first RF safety signal having a first unique identification code to identify itself as a first type of safety signal;
transmitting a second radio frequency (RF) safety signal from the one or more safety signal sources, the second RF safety signal having a second unique identification code to identify itself as a second type of safety signal;
the first type of safety signal operable to cause all electronic devices within the danger area to enter into a safe mode;
the second type of safety signal operable to disable RF communications on any electronic devices capable of RF communications;
the first type of safety signal being incorporated into a normal communications protocol of the electronic device;
the second type of safety signal being incorporated into the normal communications protocol of the electronic device;
directing the first type of safety signal to a zone of interest using beamforming techniques; and
directing the second type of safety signal to a zone of interest using beamforming techniques.

40. The method as in claim 39 wherein the safe mode comprises powering down the electronic devices.

41. The method as in claim 39 wherein the danger area comprises one of a passenger area of an airplane, a hospital or a blasting zone.

42. The method as in claim 39 wherein the first safety signal is transmitted periodically and the electronic devices will automatically exit the safe mode if a predetermined time has elapsed prior to receiving the periodic re-transmission of the first safety signal.

43. (canceled)

44. The method as in claim 39 wherein the second safety signal is transmitted periodically and the electronic devices will automatically re-enable RF communications if a predetermined time has elapsed prior to receiving the periodic re-transmission of the second safety signal.
